(19) United States
(12) Patent Application Publication
(10) Pub. No.: US 2025/0062051 A1
(43) Pub. Date: Feb. 20, 2025

(54) Insulation System, Including a Polymer Blend

(71) Applicants: Siemens Aktiengesellschaft, München (DE); Siemens Mobility GmbH, München (DE)

(72) Inventors: Steffen Lang, Hallerndorf (DE); Florian Schemmel, Nürnberg (DE); Niels Müller, Georgensgmünd (DE); Marek Maleika, Fürth (DE)

(73) Assignees: Siemens Aktiengesellschaft, München (DE); Siemens Mobility GmbH, München (DE)

(21) Appl. No.: 18/721,396

(22) PCT Filed: Dec. 13, 2022
(86) PCT No.: PCT/EP2022/085628

§ 371 Date: Jun. 18, 2024

(30) Foreign Application Priority Data
Dec. 20, 2021 (DE) 20 2021 106 928.7
Dec. 20, 2021 (EP) 21216016.2

(51) Int. Cl. H01B 3/30; H01B 3/46; H02K 3/30

(52) U.S. Cl. CPC H01B 3/303; H01B 3/46; H02K 3/30

(57) ABSTRACT

Various embodiments of the teachings herein include an insulation system. An example includes a polymer blend in the form of a solid two-dimensional insulation material, a material for wire insulation by means of extrusion and/or an injection-molded and/or compression-molded article. The blend is resistant to partial discharges and at least partly replaces any mica content in the insulation system. The blend comprises at least three blend partners including at least one copolymer based on polyetherimide and siloxane blended with at least two high-temperature thermoplastics. At least of one the high-temperature thermoplastics is in semicrystalline form, such that spherulites are detectable in the polymer blend.

### CROSS-REFERENCE TO RELATED APPLICATIONS

This application is a U.S. National Stage Application of International Application No. PCT/EP2022/085628 filed Dec. 13, 2022, which designates the United States of America, and claims priority to EP Application No. 21216016.2 filed Dec. 20, 2021 and DE Patent Application No. 20 2021 106 928.7 filed Dec. 20, 2021, the contents of which are hereby incorporated by reference in their entirety.

### TECHNICAL FIELD

The present disclosure relates to insulation of electrical conductors against partial discharge in the mid-and high-voltage range. Various embodiments of the teachings herein include insulation systems for an electrical machine and/or improved partial discharge resistance for polymeric insulation system components.

### BACKGROUND

Electrical machines with a stator, for example motors and generators in the mid-and high-voltage range, have electrical conductors, a main insulation, a winding insulation with part-conductor insulation and a laminated stator core. The main insulation serves the purpose of electrically insulating the conductors from one another, from the laminated stator core, and from the environment. The winding insulation insulates the windings of the coil from one another. In the operation of the electrical machine, electrical partial discharges can form what are called treeing channels in the mica-containing main insulation. The treeing channels can result in electrical breakdown through the main insulation.

In the low-voltage range, where wires and cables are used, there will not necessarily be electrical discharges in operation, and so no barrier against partial discharges is required in that case. The “mid-and high-voltage range” in the present context refers to electrical engineering technology that works with a high voltage in the range above 700 V up to and including 52 kV. This also includes the insulation systems that are of interest for fast-charging drive systems for the automotive industry.

A barrier in the form of an insulation system to counter partial discharges has to date been achieved mainly via the use of sheet silicate, especially of mica, in the main insulation, which has high partial discharge resistance. The mica is processed in the form of platelet-shaped mica particles having a conventional particle size of several hundreds of micrometers up to several millimeters to give a mica paper, which is subsequently placed onto and bonded to a carrier, such as a glass fiber weave and/or insulation film, such that the mica particles give rise to the two-dimensional insulation material in the form of a broad mica sheet. This broad mica sheet is cut into a mica tape which is wound around the conductor to establish the main insulation. Subsequently, in order to establish the insulation system, the mica wrapping tape for electrical insulation is impregnated with a liquid synthetic resin, and then the synthetic resin is cured.

The mica particles used for the purpose can be broken up in an automated manner only with difficulty; there are therefore recurring suspicions that this is done partly by child labor in some countries. The establishment of an insulation system with a two-dimensional insulation material as groove lining and/or with a broad mica sheet and/or a mica tape is therefore unsustainable.

There are known insulation systems—for example the system known by the “Micalastic®” brand—where the main insulation, comprising a wound mica tape as two-dimensional insulation material, is impregnated with a bisphenol epoxy resin in a vacuum pressure impregnation method.

Micalastic® is also known from EP2763142A1 and DE102011083228A.

In high-voltage motors, such as traction motors and large industrial motors, the partial discharge resistance of the insulation is increased by the addition of sheet silicates, mainly mica. For this purpose, in the corresponding insulation systems, the mica is applied in the form of papers—or in the case of two-dimensional insulation materials in the form of laminates-meaning that the mica paper is applied to carrier films or carrier weaves or carrier papers, such as calendered m-aramid—for example in the form of Nomex®—in order to improve its mechanical strength and to enable better processibility of the mica paper.

In the case of insulation systems with mica tapes, the paper is bonded to a glass weave carrier and/or to a PET and/or PI film and cut into narrow rolls that are then wound around the coil. Even in the case of part-conductor insulations, mica, for example, can be wound around the part-conductors in the form of a prepreg and hence the partial discharge resistance of the part-conductor insulation can be improved. In principle, for production of the corresponding insulation systems, all these mica laminates may be impregnated with an impregnation resin after application and consolidated.

In particular, insulation systems with groove linings are used for traction motors as well, and these, because of the requirements, have to date been made from mica-containing laminates equipped with, for example, m-aramid and polyimide as carrier film. In order to gain maximum performance from the machine, they are operated at the maximum possible current densities, but this also means that significant losses arise in the form of heat. Traction motors are especially also operated at temperatures above 150° C.

DE 10 2020 208760 describes a two-dimensional insulation material composed of a copolymer of a polyetherimide with a siloxane, but this exhibits a softening point at elevated temperature up to 220° C., as can occur in traction motors. One reason for this is that, in the copolymer of polyetherimide and siloxane, because of the relatively nonpolar side groups of the siloxane, these act as an “impurity” with respect to the pure polyetherimide, which lowers the glass transition temperature. Although these polyetherimide-siloxane copolymers can be produced in two-dimensional film form via suitable extrusion methods, and these in turn have sufficient elasticity for use—in ready-cut form—as wrapping tapes inter alia, these are not usable as wrapping tapes in the operating temperature range of traction motors, for example, at more than 150° C., especially more than 170° C.

In the case of extruded wire insulations or in the case of spun wire insulations in tape form, and not the solvent-containing wire enamels, it is conventional to use PEEK, PI, PAI, PPS, PEI, polyesterimide (thermoset) and the like. There are also insulation systems comprising injection-molded articles, for example tooth-wound coils.

The conventionally used polymeric constituents of insulation systems have only low or even zero partial discharge resistance with respect to electrical discharges. The partial discharge resistance of the insulation systems conventionally comes from the mica used. In particular, the thermoplastic constituents of the conventional insulation systems are fundamentally not resistant to partial discharges without mica.

A known means of improving the partial discharge resistance of a wrapped main insulation comprising synthetic resin—i.e. polymer encapsulation—is the use of nanoscale particles that are dispersed in the impregnation medium prior to impregnation. However, the presence of the particles shortens the pot life of the synthetic resin or of the impregnation medium, which is manifested in particular in progressive polymerization of the synthetic resin before impregnation. Corresponding experiments with filled impregnation media are not currently envisaged for economic reasons, because too many processing problems have occurred. In the case of the solid insulation materials, such as the two-dimensional insulation materials of insulation systems, the replacement of mica has not been studied to date.

### SUMMARY

Teachings of the present disclosure provide materials for wire extrusion, especially for wire extrusion of any flat or round wires provided and/or of plug-in coils and/or what are called hairpin flat wires for stators in electric motors and generators and/or in main insulation. These may find use in particular in traction motors for electrical vehicles. For example, some embodiments of the teachings herein include an insulation system comprising a polymer blend in the form of a solid two-dimensional insulation material, of a material for wire insulation by means of extrusion and/or of an injection-molded and/or compression-molded article, characterized in that the polymer blend is resistant to partial discharges, at least partly replaces the mica content in the insulation system and is a polymer blend of at least three blend partners in which there is at least one copolymer based on polyetherimide and siloxane blended with at least two high-temperature thermoplastics, where at least one of the high-temperature thermoplastics is in semicrystalline form, such that spherulites are detectable in the polymer blend.

In some embodiments, each of the blend partners is present in the polymer blend in a proportion of 1% to 70% by weight.

In some embodiments, polyetherimide PEI is present in the polymer blend as high-temperature blend partner.

In some embodiments, polyetheretherketone is present in the polymer blend as semicrystalline high-temperature blend partner.

In some embodiments, the polymer blend is in the form of a film and/or laminate.

In some embodiments, a sulfur-containing polymer component is present in the polymer blend.

In some embodiments, the sulfur-containing polymer component is present in the polymer blend in an amount of up to 25% by weight.

In some embodiments, the blend partners are all present in roughly the same proportions by mass.

In some embodiments, the copolymeric polymer blend component based on polyetherimide and siloxane has the greatest number of parts by mass in the polymer blend.

In some embodiments, a PEK has the greatest number of parts by mass in the polymer blend.

In some embodiments, PEI has the greatest number of parts by mass in the polymer blend.

In some embodiments, the sulfur-containing polymer component has the greatest number of parts by mass in the polymer blend.

In some embodiments, a proportion of silicon atoms in the range from 1% to 25%, based on all atoms in the copolymer, is present in the copolymer based on polyetherimide and siloxane.

In some embodiments, one or more oxidation-inhibiting additive(s) are present in the polymer blend.

As another example, some embodiments include the use of a polymer blend as described herein in a wire extrusion as part-conductor insulation or winding insulation and/or as main insulation in hairpin windings with subsequent fixing by encapsulation, impregnation, trickle impregnation, dipping and/or injection molding.

As another example, some embodiments include the use of a polymer blend as described herein in an injection molding method for production of an electrical main insulation or parts of an electrical main insulation of a stator of an electric motor or generator.

As another example, some embodiments include the use of a polymer blend as described herein in a compression molding method for production of an electrical insulation and/or parts of an electrical insulation of a stator of an electric motor or generator.

As another example, some embodiments include the use of a polymer blend as described herein as laminate or film for production of at least part of an insulation system with impregnation by vacuum pressure impregnation.

As another example, some embodiments include the use of a polymer blend as described herein as groove lining for the insulation of a stator of an electric motor or generator.

As another example, some embodiments include an electrical machine having a stator having an electrical insulation system in which a polymer blend as described herein is detectable.

### BRIEF DESCRIPTION OF THE DRAWINGS

The teachings of the present disclosure are elucidated in detail hereinafter by figures that show measurements on illustrative embodiments:

FIGS. 1 and 2 show diagrams of dynamic-mechanical thermoanalyses DMA.

FIG. 3 shows an illustrative construction of a two-dimensional insulation material incorporating teachings of the present disclosure.

### DETAILED DESCRIPTION

There is also a need for a material by which, in the injection molding process, the applying of a thermally stable and/or partial discharge-resistant insulation is possible without mica-containing wrapping tape and also without subsequent vacuum impregnation (“VPI”) methods. Mica has been used to date wherever high-temperature and partial discharge in stators for electric motors and generators can damage an insulation in polymeric form. In order to replace mica, attempts have now been made to create the corresponding properties in polymers with fillers, especially with nanoparticles. However, this has been without resounding economic success to date.

Teaching of the present disclosure may implement, or increase, partial discharge resistance of the polymeric components of an insulation system and provide a substitute for mica in insulation systems in general and for mica tapes and/or mica paper in particular, and hence to provide a polymeric material for wire extrusion, injection molding, compression molding and/or a two-dimensional insulation material s partial discharge resistance, and the glass transition temperature and/or melting point of which is at least above 150° C. or higher, and/or which has a temperature index of 180° C. or—if possible—even higher.

Teachings of the present invention include an insulation system comprising a material in the form of a
solid two-dimensional insulation material, and/or
material for wire insulation by means of extrusion and/or
injection-molded article and/or
compression-molded article,
   characterized in that the material is resistant to partial discharges, at least partly replaces the mica content in the insulation system and is a polymer blend of at least three blend partners in which there is at least one copolymer based on polyetherimide and siloxane blended with at least two high-temperature thermoplastics, where at least one of the high-temperature thermoplastics is in semicrystalline form.

Uses of the materials described herein include, for example, the use of this polymer blend by wire extrusion as part-conductor insulation or winding insulation and/or as main insulation in hairpin coils. A fixing operation is preferably also envisaged here for production of the insulation system-for example fixing in the groove—by encapsulating, impregnating, trickle-impregnating, dipping and/or by injection molding with a synthetic resin. For example, it is possible to fix a part-conductor insulated by wire extrusion in the groove by injection molding.

Another illustrative use of the polymer blend is in the method of injection molding, for example of a stator of an electric motor or generator. The polymer blend may be used in a method of compression molding for production of the insulation system and/or of parts thereof, especially of a stator of an electric motor or generator.

The polymer blend may be used in the form of a film, as for example in the case of utilization as a solid insulation material, especially in tape form, as part of a winding insulation and/or main insulation as mentioned, producible by means of a wrapping tape—e.g. part-conductor insulation.

The teachings of the present disclosure may include the use of the polymer blend in the form of a laminate-especially as two-dimensional insulation material, for example for groove linings of a stator—even without further fixing or stabilization by encapsulation, for example.

The teachings of the present disclosure may include the use of the polymer blend in the form of a film in tape form and/or of a laminate in tape form as at least part of a wrapping and of an insulation system impregnated and cured by the VPI process. In VPI, the tape comprising the polymer blend is then impregnated by means of synthetic resin.

In some embodiments, polyetherimide-PEI-is present in the polymer blend as high-temperature (“HT”) thermoplastic blend partner, for example in amorphous form. In some embodiments, a polyetherketone and/or a mixture of various polyetherketones is present in the polymer blend as semicrystalline high-temperature (“HT”) thermoplastic.

“Polyetherketones”-PEKs-are polymers wherein the molecular backbone has alternating ketone (R—CO—R) and ether functionalities (R—O—R). Examples of good suitability are polyaryletherketones-PAEKs-where there is an aryl group linked in the 1, 4 positions in each case between the functional groups. The rigid backbone of the polyetherketones and in particular of the polyaryletherketones imparts very high glass transition temperatures—Tgs—and/or melting points to the materials by comparison with other polymers, and they are therefore usable according to the invention as at least one blend partner of the insulation polymer blend material comprising at least three blend partners for replacement of mica with partial discharge-resistant polymer material.

Suitable polyetherketones include but are not limited to:
poly(etheretherketone)—PEEK,
poly(etherketoneketone)—PEKK,
poly(etheretheretherketone)—PEEEK,
poly(etheretherketoneketone)—PEEKK,
poly(etherketonetherketoneketone)—PEKEKK—and/or
polyaryletherketone—PAEK,
   and any combinations and/or mixtures of the abovementioned compounds.

To the extent that they have already been tested, the polyetherketones mentioned are miscible and combinable as desired with one another and with the two other blend partners, especially also with the copolymer based on polyetherimide and siloxane.

In some embodiments, each of the at least three polymer blend partners—the at least one copolymer and the two thermoplastics, at least one of which is in semicrystalline form—is each present in the polymer blend in a concentration between 1% and 70% by weight.

A mixture of 3 blend partners (a copolymer, especially a siloxane-polyetherimide copolymer, with at least one thermoplastic in semicrystalline form) in the blend results in a stable mixture which is usable as unfilled material for production of an insulation and especially also suitable for film production.

In a semicrystalline blend partner there are spherulites, which refers to a spherical superstructure unit that is typical of thermoplastics. The term “spherulite” refers generally to a spherical and/or radial aggregate of crystals; spherulites are themselves not crystals in the crystallographic sense, but rather aggregates, i.e. accumulations of very many crystalline regions of relatively small size. These may be detected by x-ray diffraction. In a polymeric superstructure with spherulites, crystals are in a radially symmetrical arrangement and are joined via amorphous intermediate regions. Since spherulites comprise crystalline regions and are hence birefringent, they can be detected with the aid of polarization microscopy. The size detectable by light microscopy is between 1 μm and several hundreds of micrometers. In the case of very small spherulites, the above-described pattern is no longer apparent under microscope. All that can still be seen is diffuse scatter of the light.

“Blend material”, “polymer blend”, or “blend” for short refers in the present context to purely physical mixtures of two or more different polymers. The properties of the resultant plastics differ from those of the original polymers. In the case of this purely physical mixture, no new chemical bonds are formed between the macromolecules. Polymer blends are identified for short by a “+” between the constituents; by contrast, continuous sequences of letters are used in the case of copolymers.

“Two-dimensional insulation material” refers to a material which is solid under standard conditions and takes the form, for example, of a foldable material, for example in particular in the form of a laminate and/or film. The laminate may be at least dilaminar, in which case the laminas—e.g. in turn—are bonded by lamination adhesive. There may be at least two laminas of the same material, but also different materials.

It is possible here for the laminate to include all or some laminas of such a laminate that forms a two-dimensional insulation material from one or more different working examples of a polymer blend and/or a combination of at least one lamina of a polymer blend combined with a lamina of another material that serves, for example, to cover the polymer blend in the production of the insulation system. “Other material” used in a laminate that forms a two-dimensional insulation material may, for example, be a lamination paper as used in the prior art for groove linings, for example an aramid paper, for example made of m-aramid.

On the other hand, a “two-dimensional insulation material” may also take the form of a bendable, flexible film which may be monolaminar, but under some circumstances may also be multilaminar, i.e. a bendable, flexible laminate of multiple laminas.

Abbreviations used for polymers usable here as blend partners alongside the copolymer based on polyetherimide and siloxane are DIN-standardized sequences of capital letters that are largely in accordance with the American ASTM standard. For example, PEK stands for polyetherketone and PEI for polyetherimide.

Copolymers refer in turn to polymers composed of two or more different kinds of monomer unit. Copolymers may take the form of random copolymers, gradient copolymers, alternating copolymers, block copolymers and graft copolymers.

In some embodiments, the solid two-dimensional insulation material, which is usable, for example, as substitute for a mica tape of a wrapping tape insulation for the VPI process, takes the form of a film or laminate in a broad roll or of a tape in a narrow roll or of a section of a film or laminate in tape form. This tape—for example—composed of a polymer blend according to the invention may be impregnated and cured in a VPI process with a synthetic resin, for example a thermoset, and then fixed in the arrangement in the insulation system, for example for the main insulation of a stator.

In some embodiments, the use of one or more sulfur-containing polymers as additional blend partners—in each case either in semicrystalline or amorphous form—has been found to be suitable, for reasons including that film production and also processing by extrusion is possible here too without significant separation from the residual blend partners, and partial discharge resistance is improved once again.

There are sulfur-containing polymers both in semicrystalline and in amorphous form; the sulfur-containing polymers insemicrystalline form, for example polyphenylene sulfide—PPS—are also used primarily to increase partial discharge resistance, but also because of the spherulites in the blend, which bring about a certain residual strength above the Tg, such that the polymeric constituents of the insulation system do not drip off at operating temperatures above the Tg, but remain in rubberlike form within the insulation system and solidify again on cooling.

In particular, it is possible to add a sulfur-containing polymer compound selected from the class of the sulfur-containing polymers, such as that of the polysulfones—PSU—comprising, for example, polyphenylene sulfide—PPS, polyphenylene sulfone—PPSU, polyether sulfone—PESU, and/or polyarylene sulfone—PAS, polybisarylsulfone, such as polybisphenylenesulfone, etc., to the polymer blend according to the invention alone or in any desired combinations.

In some embodiments, the amount of added sulfur-containing polymer is in the range between 1% by weight and 25% by weight, especially between 3% by weight and 20% by weight, or between 4% by weight and 15% by weight.

All the sulfur-containing high-temperature thermoplastics mentioned may be used alone and/or in any combinations and mixtures.

In some embodiments, the three blend partners (copolymer and—for example—PEI and PEEK) are present in roughly the same proportions by mass in the blend, where, for example, all three partners are in the range between 15% by weight and 33% by weight, especially between 20% by weight and 30% by weight, or between 23% by weight and 27% by weight.

In some embodiments, the copolymer based on polyetherimide and siloxane is present in the smallest proportion, in which case the two thermoplastic blend partners are both in higher proportions by mass, which may again be the same or different.

In some embodiments, copolymer based on polyetherimide and siloxane is present at least at 15% by weight of the polymer blend, PEI at at least 17% to 20% by weight, and PEK, e.g. PEEK, at at least 35% by weight.

In some embodiments, PEI is present at at least 12% by weight, copolymer based on polyetherimide and siloxane at at least 20% by weight, and PEEK at at least 33% by weight.

In some embodiments, the polymer blend may also be in filled form, where reinforcing fillers, for example reinforcing fibers, especially glass fibers, for example in the form of short glass fibers, may be present as filler.

The “copolymer based on polyetherimide and siloxane”, even in unblended form, has potential as insulation material in the mid- and high-voltage range with regard to stability to partial discharges. However, the softening temperature of the copolymer alone as two-dimensional insulation material is only slightly above 170° C., and so this cannot be used in unchanged form as two-dimensional insulation material in an insulation system at higher operating temperatures, especially at operating temperatures above 180° C.

In some embodiments, by virtue of a blend of copolymer based on polyetherimide and siloxane with two thermoplastics, here PEI and PEEK in particular, in an amount of, for example, 10% to 90% by weight of PEI and PEEK together, the copolymer gives rise to such an improved two-dimensional insulation material is which processible as a film and is usable within a temperature range—meaning an operating temperature range—of an electrical machine insulated therewith of, for example, 170° C. up to 250° C.

Drive motors and traction motors in particular are electrical machines which are useful because they are operated at high temperatures, i.e. temperatures above 155° C. The operating temperature of the motor may be below the Tg of the polymer blend which is used according to the teachings of the present disclosure.

By means of a polymer blend according to a working example, for example with 25% by weight of copolymer, 35% by weight of PEI and 40% by weight of PEEK, the production of a film as mica-free two-dimensional insulation material is possible. The solid insulation materials which have been used to date as wrapping tape insulation and which are fundamentally mica-containing can be produced here without sheet silicate and especially without mica, and in particular in equally good or even improved quality. For this purpose, in particular, the aspect of sustainability should also be mentioned, since “mica” is a natural product.

The teachings herein thus make it possible to conserve a natural product which is predominantly broken up manually because a polymer blend as described herein may be suitable as two-dimensional insulation material and as solid insulation material, and high resistance to partial discharges has been shown for motors of the abovementioned heat classes up to 250° C.

Partial discharge resistance is assessed via surface profilometer by means of the determination of specific erosion volume after electrical aging. This is conducted in accordance with IEC 60343. The experimental setup and test conditions can be found in the publication: N. Müller; S. Lang; R. Moos: “Influence of ambient conditions on electrical partial discharge resistance of epoxy anhydride based polymers using IEC 60343 method”. Transactions on Dielectrics and Electrical Insulation 2019.

In some embodiments, the copolymer based on polyetherimide and siloxane is a block copolymer. In some embodiments, the proportion of siloxane in the copolymer is in the range from 0.1% by weight to 90% by weight, especially 10% by weight to 60% by weight and especially 20% by weight to 40% by weight, based on the total weight of the copolymer.

In some embodiments, the atomic proportion of silicon atoms in the copolymer is 0% to 30% atom percent, especially from 0% to 25%, especially 0% to 15%.

In some embodiments, the polyetherimide-siloxane copolymer is a block copolymer of the general formula (I)

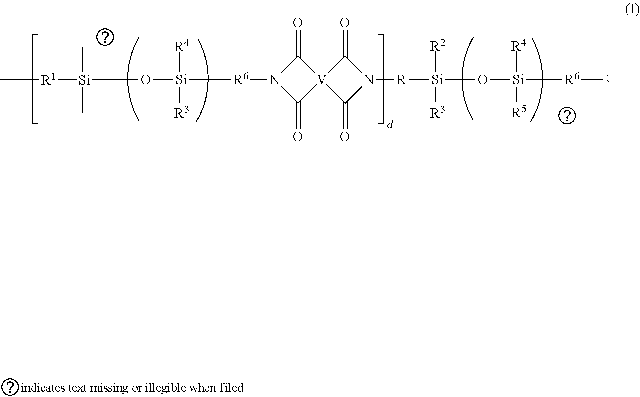

where

R¹⁻⁶ are the same or different and are selected from the group of the
substituted or unsubstituted, saturated, unsaturated or aromatic monocycles having 5 to 30 carbon atoms,
substituted or unsubstituted, saturated, unsaturated or aromatic polycycles having 5 to 30 carbon atoms,
substituted or unsubstituted, saturated hydrocarbons having 1 to 30 carbon atoms,
substituted or unsubstituted, unsaturated hydrocarbons having 2 to 30 carbon atoms;

V is a tetravalent linker group selected from the group of the
substituted or unsubstituted, saturated, unsaturated or aromatic monocycles and polycycles having 5 to 50 carbon atoms,
substituted or unsubstituted, saturated hydrocarbons having 1 to 30 carbon atoms,
substituted or unsubstituted, unsaturated hydrocarbons having 2 to 30 carbon atoms,
and any combination of linker groups that comprise at least one of the aforementioned groups;
g is 1 to 30 and
d is 2 to 20.

In some embodiments, one or more additives may be present in the copolymer. For example, one or more metal oxide(s) may be used, for example TiO₂ and/or those with one of the following empirical formulae: Na₈Al₆Si₆O₂₄S₄ and/or Na₆Al₆Si₆O₂₄S₂. Further additives may be Fe₂O₃ and/or MnFe₂O₄ and/or electrically nonconductive carbon-based fillers, for example industrial carbon black suitable additives. If required, the additive particles may be provided partly or wholly with an SiO₂ coating, over the full surface or part of the surface, in the two-dimensional insulation material, i.e. the part of the insulation system which is comparable to the mica tape of the insulation systems that have been customary to date.

These additives are especially also oxidation-inhibiting, and so the heat class and/or temperature index of a two-dimensional insulation material produced therewith can be increased further.

Additives are added, for example, in the production of the blend. Further additives, leveling aids, color pigments, quartz particles and others may be added to the blend and/or the impregnation medium for production of the insulation system.

“Siloxane” in the present context refers in principle to a compound having at least one —Si—O—Si— unit, especially those that form a Si—O—Si backbone in the polymer as is customary in silicones. For example, a polydialkylsiloxane, such as polydimethylsiloxane, or a polydiarylsiloxane, such as polydiphenylsiloxane, are simple forms of a siloxane. There are of course also mixed forms of siloxanes, for example a polyarylalkylsiloxane.

Polyetherimide or “PEI” refers to the known thermoplastic, which has various uses because it is stable to high temperature and classified as flame-retardant. This is especially because it shows low evolution of smoke if it nevertheless burns. PEI has high stability, including high electrical breakdown resistance, and low weight, and is resistant to UV light and gamma rays. In particular, PEI is commercially available as “ULTEM®”.

In some embodiments, the polyetherimide is used firstly for formation of the copolymer with siloxane; in other words, the monomers of the polyetherimide and the monomers of the siloxane are cured together to form a polymer.

Secondly, irrespective of the copolymer used, PEI may be used for production of the polymer blend, in the blending of the copolymer to form the polymer blend in an embodiment of the teachings herein.

Polyetheretherketone PEEK is a high-temperature-stable thermo-plastic and is part of the group of the polyaryletherketones. PEEK is solid at room temperature with a melting temperature of 335° C. PEEK is in semicrystalline form and is stable to almost all organic and inorganic chemicals. Moreover, it has low flammability and shows high partial discharge resistance. PEEK is sold, for example, in radiopaque form by Evonik®.

The polymer blend is formed by simply mixing the at least three components: copolymer with two thermoplastics, e.g. PEI and PEEK. The properties of the blend, especially with regard to thermal stability, correspond neither to those of the copolymer nor to those of the thermoplastics on their own. A polymer blend in this sense is a purely physical mixture; no new chemical bonds are formed between the macromolecules.

The impregnation resin used to form the synthetic resin of a wrapping tape insulation and/or of a slot cell from the two-dimensional film material by, for example, a VPI process on the wrapped insulation, i.e. for impregnation of the wrapping tape insulation, is preferably a thermoset. It is possible here to use, for example, polyester, formaldehyde, epoxide, novolak, silicone, polyesterimide, polyurethane, and any mixtures, blends and copolymers of the aforementioned compounds. Impregnation resins for groove linings and/or wrapping tape insulations are common knowledge, from the above-cited patent specifications among others. The solid insulants are impregnated with these impregnation resins, and then the resin is cured in order to complete the insulation system.

For production of a slot cell, for example, a film composed of the polymer blend is used in one working example, in that the film is embedded either on its own or as a laminate between two m-aramid=meta-aramid papers. m-Aramid and related aramid polymers are related to nylon but have aromatic backbones and are therefore stiffer and more durable. m-Aramid is an example of a meta variant of the aramids; for example, Kevlar® is a para-aramid. m-Aramids have excellent thermal, chemical and radiation stability for a polymer material. m-Aramid withstands temperatures of up to 370° C.

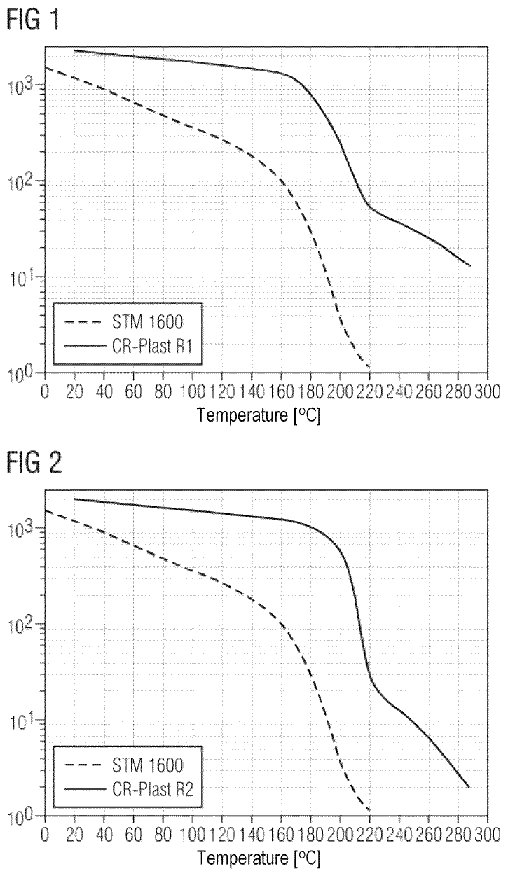

FIGS. 1 and 2 show diagrams of dynamic-mechanical thermoanalyses DMA, which are acknowledged to be the most sensitive method for measurement of glass transition temperature Tg. Measurement was effected with the Discovery DMA850 dynamic-mechanical analyzer from TA Instruments. The storage modulus is measured, which corresponds roughly to the modulus of elasticity, plotted against temperature.

What is common to the two diagrams is that a rapid drop takes place from a certain temperature; in other words, Tg drops rapidly or the polymer blend loses its strength, but the polymer blend does not break down-although it was possible to see a rubberlike state in the examples described.

FIG. 1 shows, by dotted lines, as
reference sample a trace for the unblended block copolymer
   here a sample of the Siltem® STM1600 material from Sabic-and
as a solid line a working example of the present invention STM1600®+PPS+PEEK+PEI.

It is clearly apparent that the polymer blend composed of the copolymer+PPS+PEEK+PEI retains its stiffness and its strength for significantly longer than the reference sample, and even at 240° C. still shows a modulus of elasticity or storage modulus of more than 50 MPa. The pure copolymer, by contrast, shows a much lower Tg, and has this value of 50 MPa even at 180° C.

FIG. 2 also shows storage modulus plotted against temperature, but of a second working example of the invention, again against the reference of the pure copolymer. Again, a very high Tg of more than 180° C. can be seen. This working example shows the polymer blend in a different mixture, this time with PEI in an amount of 50% by weight. The copolymer, PEEK and the sulfur-containing polymer component together also give 50% by weight, with PPS present therein at only 5% by weight.

A somewhat steeper drop in modulus of elasticity is apparent, again in the comparison of the Siltem®1600 reference sample shown by a dotted line and the working example, shown by a solid line, of a polymer blend of Siltem®1600 copolymer, PPS, PEEK and PEI, including 50% by weight of PEI.

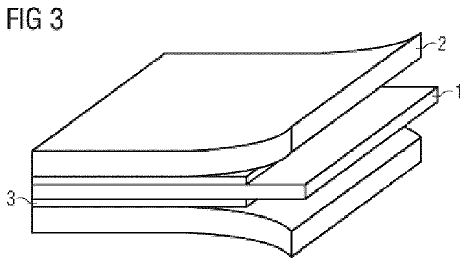

FIG. 3 shows an illustrative construction of a two-dimensional insulation material in one embodiment of the invention. FIG. 3 shows, in the middle, a lamina of a polymer blend 1 in one working example of the present invention. This lamina is covered on both sides by a cover lamina 2, for example an aramid paper. The three laminas are bonded by means of lamination adhesive 3.

The polymer blends described herein show many potential advantages, including reproducibility which is typical of synthetic materials, which constitutes an advantage over mica, being a natural product. In addition, all relevant mica components in the respective insulation systems may be replaced by the blend proposed. The production of films from the material is very inexpensive and simple via the process of extrusion.

Any necessary further processing of the films to laminates (as in the prior art, the further processing of the mica papers to give laminates) is possible in a very simple manner. Further processing to narrow rolls as mica tape substitute is possible too. The wire insulations can be produced by wire extrusion. In principle, the radii of curvature of the thermoplastic insulation mentioned may be chosen so as to be tighter than those of a mica-containing insulation, since material elongations are much higher. This can give rise to design benefits. In addition, however, the injection molding has also given rise to an additional processing method that can very easily replace the main insulation. It used to be the case that this was produced in a costly and inconvenient manner by mica tape wrapping of the coil and a subsequent impregnation process, followed in turn by a curing process.

If the polymer blend is extruded as a thick film, it is also possible to produce what is called a slot insert and/or slot lining in a simple manner, in which the film is present on its own, or else as a laminate, embedded between two m-aramid papers.

A polymer blend incorporating teachings of the present disclosure shows good partial discharge resistance and also high glass transition temperatures, Tg, as demonstrable by diagrams as shown in the figures. It has thus been found that, with a polymer blend as described in the present context composed of at least one copolymer based on polyetherimide and siloxane and two high-temperature thermoplastics in which spherulites are detectable, it is possible to replace or at least greatly reduce the use of mica and/or mica papers in electrical insulations.

What is claimed is:

1. An insulation system comprising:
a polymer blend in the form of a
solid two-dimensional insulation material,
material for wire insulation by means of extrusion and/or an
injection-molded and/or compression-molded article;
wherein the polymer blend is resistant to partial discharges, and at least partly replaces any mica content in the insulation system and
wherein the polymer blend comprises at least three blend partners including at least one copolymer based on polyetherimide and siloxane blended with at least two high-temperature thermoplastics; and
at least one of the high-temperature thermoplastics is in semicrystalline form, such that spherulites are detectable in the polymer blend.

2. The insulation system as claimed in claim 1, where each of the at least three blend partners is present in the polymer blend in a proportion of 1% to 70% by weight.

3. The insulation system as claimed in claim 1, wherein one of the at least three blend partners comprises a polyetherimide PEI.

4. The insulation system as claimed in claim 1, wherein one of the at least three blend partners comprises a polyetheretherketone.

5. The insulation system as claimed in claim 1, wherein the polymer blend forms a film and/or a laminate.

6. The insulation system as claimed in claim 1, wherein the polymer blend includes a sulfur-containing polymer.

7. The insulation system as claimed in claim 6, wherein the sulfur-containing polymer component is present in the polymer blend in an amount of up to 25% by weight.

8. The insulation system as claimed in claim 1, wherein the blend partners are all present in roughly the same proportions by mass.

9. The insulation system as claimed in claim 1, wherein the at least one copolymeric polymer blend component has the greatest number of parts by mass in the polymer blend.

10. The insulation system as claimed in claim 1, wherein a PEK component has the greatest number of parts by mass in the polymer blend.

11. The insulation system as claimed in claim 1, wherein a PEI component has the greatest number of parts by mass in the polymer blend.

12. The insulation system as claimed in claim 6, wherein the sulfur-containing polymer component has the greatest number of parts by mass in the polymer blend.

13. The insulation system as claimed in claim 1, wherein a proportion of silicon atoms in the range from 1% to 25%, based on all atoms in the copolymer, is present in the copolymer in the forms of polyetherimides and siloxanes.

14. The insulation system as claimed in claim 1, wherein the polymer blend includes an oxidation-inhibiting additive.

15. A method as recited in claim 21, further comprising:
using the polymer blend in a wire extrusion as part-conductor insulation or winding insulation and/or as main insulation in hairpin windings; and
fixing the polymer blend by encapsulation, impregnation, trickle impregnation, dipping and/or injection molding.

16. The method as recited in claim 21, further comprising using the polymer blend in an injection molding method for production of an electrical main insulation or parts of an electrical main insulation of a stator of an electric motor or generator.

17. The method as recited in claim 21, further comprising using the polymer blend in a compression molding method for production of an electrical insulation and/or parts of an electrical insulation of a stator of an electric motor or generator.

18. The method as recited in claim 21, further comprising use the polymer blend as laminate or film for production of at least part of an insulation system with impregnation by vacuum pressure impregnation.

19. The method as recited in claim 21, further comprising using the polymer blend as groove lining for the insulation of a stator of an electric motor or generator.

20. An electrical machine comprising:
a stator with an electrical insulation system;
wherein the electrical insulation system includes a polymer blend;
wherein the blend is resistant to partial discharges, and at least partly replaces any mica content in the insulation system, and the polymer blend comprises at least three blend partners including at least one copolymer based on polyetherimide and siloxane blended with at least two high-temperature thermoplastics, and at least one of the high-temperature thermoplastics is in semicrystalline form, such that spherulites are detectable in the polymer blend.

21. A method comprising:
use of a polymer blend in an insulation system;
wherein the polymer blend is resistant to partial discharges, and at least partly replaces any mica content in the insulation system, and the polymer blend comprises at least three blend partners including at least one copolymer based on polyetherimide and siloxane blended with at least two high-temperature thermoplastics, and at least one of the high-temperature thermoplastics is in semicrystalline form, such that spherulites are detectable in the polymer blend.
